(19) United States
(12) Patent Application Publication
(10) Pub. No.: US 2007/0261406 A1
(43) Pub. Date: Nov. 15, 2007

(54) Systems and methods of reducing NOx emissions in internal combustion engines

(75) Inventor: Chenna Krishna Rao Boyapati, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/432,087

(22) Filed: May 12, 2006

(51) Int. Cl. F02B 29/04; F02D 23/00; F02B 33/44

(52) U.S. Cl. 60/602; 60/605.2; 60/599

(57) ABSTRACT

A method of operating an internal combustion engine system comprises introducing an oxygen containing gas and a fuel into a combustion chamber of an internal combustion engine; combusting the fuel to produce an exhaust gas; introducing the exhaust gas into a turbine of a turbocharger, wherein the turbine is a variable geometry turbine; recycling a portion of the exhaust gas exiting the turbine to a compressor of the turbocharger using an EGR valve; compressing the recycled portion of the exhaust gas and compressing the oxygen containing gas to produce a compressed gas; and introducing the compressed gas on an intake stroke of a piston into the engine and closing the intake valve either before the piston reaches an end of the inlet stroke or later to the piston reaching bottom dead center.

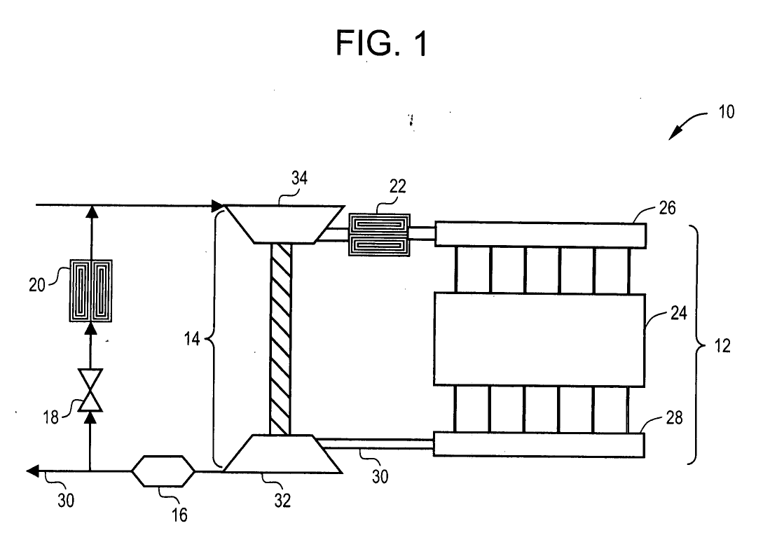

### BACKGROUND

The present disclosure generally relates to systems and methods of reducing NO_{X} emissions in internal combustion engines, and particularly to systems and methods of reducing NO_{X} emissions in internal combustion engines that employ exhaust gas recirculation (EGR).

Air pollution concerns worldwide have led to stricter emissions standards. These standards regulate the emission of oxides of nitrogen (NO_{X}) (e.g., nitric oxide (NO) and nitrogen dioxide (NO₂)), unburned hydrocarbons (HC) and carbon monoxide (CO), which are generated as a result of internal combustion (IC) engine operation. Generally, the quantity of NO_{X} produced by the IC engine is related to combustion temperature and the oxygen content of the combustion gas. For example, the NO_{X} formation is proportional to peak flame temperature and residence time. With higher oxygen content of the gas causing higher flame temperatures, which results in an increase in NO_{X}. The formation of NO_{X} is also related in part to peak combustion pressure.

One method for reducing the amount of NO_{X} in exhaust gas is to lower the combustion temperature by injecting water into the combustion chamber of the IC engine. While such water injection systems have been used with some degree of success, they can be expensive to install and often require special maintenance procedures to keep them operating efficiently. Additional problems include water storage, which can be particularly problematic for mobile applications, as well as water purity concerns. Another problem associated with water injection is that while the injection of water into the combustion chamber reduces the overall combustion temperature, it also tends to increase the overall combustion pressure, which can disadvantageously lead to the formation of additional NO_{X}.

Alternatives to water injection systems are exhaust gas recirculation (EGR) systems in which a portion of the exhaust gas is re-circulated into the intake manifold of the IC engine. The re-circulated exhaust gas mixes with the intake air charge to reduce the total oxygen content in the combustion gas, thereby lowering the amount of oxygen that is available to form NO_{X}, as well as lowering the combustion temperature. Such exhaust gas recirculation (EGR) systems have proven to be effective when used with spark ignition engines (e.g., gasoline engines).

However, incorporating EGR systems on compression ignition engines (e.g., diesel engines) has proven to be a more difficult task. One of the major problems facing compression ignition engines is particulate matter (e.g., soot). Compression ignition engines generally produce a higher amount of particulate matter compared to spark ignition engines, which can adhere to system components causing early wear or failure. Another difficulty in introducing EGR into a compression ignition engine system is the complexity of such systems and the fuel penalties that are generally incurred. In other words, it has proven considerably more difficult to design EGR systems that are practical, since most EGR systems employed in compression ignition engines systems tend to require excessive maintenance and frequent cleaning.

Accordingly, a continual need exists for improved systems and methods of reducing NO_{X} emissions in internal combustion engine systems that employ exhaust gas recirculation (EGR).

### BRIEF SUMMARY

Disclosed herein are internal combustion engine systems and methods of operating internal combustion engine systems.

In one embodiment, an internal combustion engine system comprises an internal combustion engine having an intake manifold and an exhaust manifold; a turbocharger having a turbine and a compressor, wherein the turbine is disposed downstream of and in fluid communication with the exhaust manifold, and the compressor is disposed upstream of and in fluid communication with the intake manifold; an EGR valve disposed downstream of and in fluid communication with the turbine; an EGR cooler disposed downstream of the EGR valve and in direct fluid communication with the EGR valve, wherein the EGR cooler is disposed upstream of and in fluid communication with the compressor; and an intercooler disposed downstream of and in fluid communication with the compressor, and disposed upstream of and in fluid communication with the intake manifold.

In one embodiment, a method of operating an internal combustion engine system comprises introducing an oxygen containing gas and a fuel into a combustion chamber of an internal combustion engine; combusting the fuel to produce an exhaust gas; introducing the exhaust gas into a turbine of a turbocharger, wherein the turbine is a variable geometry turbine; recycling a portion of the exhaust gas exiting the turbine to a compressor of the turbocharger using an EGR valve; compressing the recycled portion of the exhaust gas and compressing the oxygen containing gas to produce a compressed gas; and introducing the compressed gas on an intake stroke of a piston into the engine and closing the intake valve either before the piston reaches an end of the inlet stroke or later to the piston reaching bottom dead center.

The above described and other features are exemplified by the following FIGURE and detailed description.

### BRIEF DESCRIPTION OF THE DRAWINGS

The FIGURE is a schematic illustration of an embodiment of an internal combustion engine system.

### DETAILED DESCRIPTION

Disclosed herein are systems and methods of reducing NO_{X} emissions in internal combustion engines that employ exhaust gas recirculation (EGR). More particularly, by operating an internal combustion engine with EGR using a Miller cycle (e.g., early intake valve closing or late intake valve closing) in combination with a system comprising a turbocharger having a variable geometry turbine (VGT), a reduction in NO_{X} emissions is obtained while minimizing the impact on fuel consumption. Moreover, as will be discussed in greater detail below, the overall system complexity is simplified, since fewer components are employed compared to other known systems.

In the descriptions that follow, an “upstream” direction refers to the direction from which the local flow is coming, while a “downstream” direction refers to the direction in which the local flow is traveling. In the most general sense, flow through the engine tends to be from front to back, so the “upstream direction” will generally refer to a forward direction, while a “downstream direction” will refer to a rearward direction. The term “direct fluid communication” as used herein refers to a communication between a first point and a second point in a system that is uninterrupted by the presence of additional devices.

Referring to the FIGURE, a schematic illustration of an internal combustion engine system generally designated 10 is illustrated. The internal combustion engine system includes both mobile applications (e.g., automobiles, locomotives) and stationary applications (e.g., power plants). For ease in discussion, the internal combustion engine system 10 is discussed hereinafter in relation to a compression ignition engine system with the understanding that the discussion can readily be applied to other systems (e.g., systems that employ both spark ignition and compression ignition). The internal combustion engine system 10 comprises an engine 12, a turbocharger 14, a particulate filter 16, an exhaust gas recirculation (EGR) valve 18, an EGR cooler 20, and an intercooler (IC) 22. The arrangements and operations of these system components within the internal combustion engine system 10 are discussed in greater detail below.

In one embodiment, the engine 12 comprises an engine body 24, an air intake manifold 26, and an exhaust manifold 28. The air intake manifold 26 serves to deliver intake air (e.g., an oxygen-containing gas) to combustion chambers (e.g., cylinders) in the engine body 24 via intake valves (not shown). That is, the intake manifold 26 is in fluid communication with the combustion chambers. During operation, a fuel from a fuel source (not shown) is introduced into the combustion chambers. The type of fuel varies depending on the application. However, suitable fuels include hydrocarbon fuels such as gasoline, diesel, ethanol, methanol, kerosene, and the like; gaseous fuels, such as natural fluid, propane, butane, and the like; and alternative fuels, such as hydrogen, biofuels, dimethyl ether, and the like; as well as combinations comprising at least one of the foregoing fuels. The fuel is then combusted with the oxygen-containing gas to generate power.

An exhaust manifold 28 of the engine 12 is disposed in fluid communication with the combustion chambers and serves to collect the exhaust gases generated by the engine 12. The exhaust manifold 28 is in fluid communication with an exhaust conduit 30, which is disposed in fluid communication with a turbine 32 of the turbocharger 14. In one embodiment, the turbine 32 is a variable geometry turbine. As is readily understood in the art, variable geometry turbines differ from fixed geometry turbines in that the size of the inlet passageway can be varied to optimize gas flow velocities over a range of mass flow rates such that the power output of the turbine can be varied to suit varying engine demands. For example, when the volume of exhaust gas being delivered to the turbine 32 is relatively low, the velocity of the exhaust gas reaching a turbine wheel is maintained at a level that ensures efficient turbine operation by reducing the size of the inlet passageway.

In one embodiment, a turbine wheel of the turbine 32 is coaxially coupled to a compressor wheel of a compressor 34. In other words, the turbocharger 14 comprises the turbine 32 and the compressor 34 that are in operable communication with each other. For example, during operation, the exhaust gases passing through the turbine 32 causes the turbine wheel to spin, which causes a shaft to turn, thereby causing the compressor wheel of the compressor 34 to spin. The compressor acts as a type of centrifugal pump, which draws in air at the center of the compressor wheel and moves the air outward as the compressor wheel spins. The compressed air from compressor 34 is supplied to the intake manifold 26, which in turn supplies the combustion chambers. Meanwhile, the exhaust gas supplied to the turbine 32 is discharged into the exhaust conduit 30.

The particulate filter 16 is disposed downstream of and in fluid communication with the turbine 32 via the exhaust conduit 30. The particulate filter 16 acts to remove particulate matter from the exhaust gas. More specifically, the particulate matter is trapped in the particulate filter 16. Depending on the design and type of particulate filter, the particulate filter is periodically replaced or periodically regenerated as the particulate filter becomes filled with particulate matter, as a function of time, or the like. In one embodiment, the particulate filter 16 is regenerated by burning the trapped particulate matter. For example, a suitable method or regeneration includes, but is not limited to, injecting fuel into the combustion chambers of the engine body 24 after the main combustion event such that the fuel in the post combustion exhaust gases is combusted over a catalyst to generate heat.

The exhaust gas exiting the particulate filter 16 is again disposed into the exhaust conduit 30. While a substantial portion of the exhaust gas in the exhaust conduit 30 is vented to the atmosphere, a portion of the exhaust gas is selectively diverted to the EGR valve 18, which is located downstream of and in fluid communication with the particulate filter 16. The EGR valve 18 enables exhaust gas to be selectively recycled back to the intake manifold 26 of the engine 12. The EGR valve 18 can control the flow of exhaust gas as a function of NO_{X} in the exhaust gas, as a function of time, as a function of ambient conditions, notches in the case of locomotives, speed and load in the case of automobiles and stationary applications, and the like. For example, a control system (not shown), such as a computer, is disposed in operable communication with the EGR valve 18 such that the EGR valve 18 opens and closes as instructed by the computer. The type of EGR valve 18 varies depending on the application. For example, the EGR valve 18 can be a built-in type or a drop-in type. In one embodiment, the EGR valve 18 is a double-poppet type valve.

Disposed downstream of and in direct fluid communication with the EGR valve 18 is the EGR cooler 20. By having the EGR valve 18 in direct fluid communication with the EGR cooler 20 the complexity is simplified compared to other systems where other devices are disposed between the EGR valve 18 and the EGR cooler 20. For example, the use of a compressor disposed in a flow path between the EGR valve 18 and the EGR cooler 20 is eliminated. Eliminating devices between the EGR valve 18 and the EGR cooler 20 not only saves equipment costs, but also operating costs. More particularly, devices like a compressor are often associated with a fuel penalty. Therefore, any simplification of an exhaust gas recycle loop can possibly result in an increase in fuel economy.

The EGR cooler 20 acts to cool the recycled exhaust gases before the exhaust gases enter the compressor 34. In one embodiment, the recycled exhaust gases are mixed with air prior to entering the compressor 34. When gases are compressed, they heat up, which causes them to expand. Stated another way, some of the pressure increase from the compressor 34 of the turbocharger 14 is a result of heating the gases before being introduced into the engine. However, in order to increase the power of the engine, the goal is to have the greatest amount of molecules in the cylinder and not necessarily more pressure. The intercooler 22 is disposed downstream of and in fluid communication with the compressor 34, which is disposed upstream of and in fluid communication with intake manifold 26 of the engine 12. The intercooler acts to reduce the temperature of the gases before the gases enter the engine 12.

During operation, the engine 12 is operated in a Miller type cycle, which advantageously increases the power of the engine 12 compared to operating the engine using a Diesel cycle. In a Miller Cycle, the intake valve is open either longer or shorter than it normally would be open, for example, in a Diesel cycle. Miller Cycle combustion systems and processes are discussed, for example, in U.S. Pat. Nos. 2,670,595; 2,773,490; and 3,015,934.

Generally, the Miller Cycle uses compressor 34 to supply an air charge, introducing the charge on the intake stroke of the piston and then closing the intake valve before the piston reaches the end of the inlet stroke. From this point the gases in the cylinder are expanded to the maximum cylinder volume and then compressed from that point as in the normal cycle. Further, it is noted that due to gas expansion, the temperature of gas at the end of compression is lower, leading to lower NO_{X}. Due to closing the intake valve much later to bottom dead center (BDC), the compression ratio is lower than the expansion ratio. The compression ratio is then established by the volume of the cylinder at the point that the inlet valve closed, being divided by the volume of the combustion chamber. On the compression stroke, no actual compression starts until the piston reaches the point the intake valve closed during the intake stroke, thus producing a lower-than-normal compression ratio. The expansion ratio is calculated by dividing the swept volume of the cylinder by the volume of the combustion chamber, resulting in a more complete expansion, since the expansion ratio is greater than the compression ratio of the engine.

In various other embodiments, the system 10 can comprise other components such as valves, exhaust treatment devices (e.g., catalytic converters and NO_{X} traps), sensors, and the like. The arrangement of these components within the system varies depending on the application and is readily understood by those in the art.

Advantageously, the systems and method disclosed herein reduce NO_{X} emissions, while simplifying the overall system structure and increasing the efficiency of the engine. Further, the system provides NO_{X} reduction benefits with a minimum specific fuel consumption (SFC) penalty.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A method of operating an internal combustion engine system, comprising:
introducing an oxygen containing gas and a fuel into a combustion chamber of an internal combustion engine;
combusting the fuel to produce an exhaust gas;
introducing the exhaust gas into a turbine of a turbocharger, wherein the turbine is a variable geometry turbine;
recycling a portion of the exhaust gas exiting the turbine to a compressor of the turbocharger using an EGR valve;
compressing the recycled portion of the exhaust gas and compressing the oxygen containing gas to produce a compressed gas; and
introducing the compressed gas on an intake stroke of a piston into the engine and closing the intake valve either before the piston reaches an end of the inlet stroke or later to the piston reaching bottom dead center.

2. The method of claim 1, further comprising removing particulate matter from the exhaust gas before recycling the portion of exhaust.

3. The method of claim 1, further comprising cooling the portion of the exhaust gas before compressing the portion.

4. The method of claim 1, further comprising cooling the compressed gas before introducing the compressed gas to the engine.

5. The method of claim 1, further comprising varying a size of an inlet passageway of the turbine.

6. The method of claim 1, wherein the internal combustion engine is a compression ignition engine.

7. An internal combustion engine system, comprising:
an internal combustion engine having an intake manifold and an exhaust manifold;
a turbocharger having a turbine and a compressor, wherein the turbine is disposed downstream of and in fluid communication with the exhaust manifold, and the compressor is disposed upstream of and in fluid communication with the intake manifold;
an EGR valve disposed downstream of and in fluid communication with the turbine;
an EGR cooler disposed downstream of the EGR valve and in direct fluid communication with the EGR valve, wherein the EGR cooler is disposed upstream of and in fluid communication with the compressor; and
an intercooler disposed downstream of and in fluid communication with the compressor, and disposed upstream of and in fluid communication with the intake manifold.

8. The internal combustion engine system of claim 7, wherein the system further comprises a particulate filter disposed downstream of and in fluid communication with the turbine.

9. The internal combustion engine system of claim 7, wherein the turbine is a variable geometry turbine.

10. The internal combustion engine of claim 7, wherein the internal combustion engine is a compressor ignition engine.

11. An internal combustion engine system, comprising:
a compression ignition engine having an intake manifold and an exhaust manifold;
a turbocharger having a variable geometry turbine and a compressor, wherein the variable geometry turbine is disposed downstream of and in fluid communication with the exhaust manifold, and the compressor is disposed upstream of and in fluid communication with the intake manifold;
a particulate filter disposed downstream of and in fluid communication with the variable geometry turbine;
an EGR valve disposed downstream of and in fluid communication with the particulate filter;
an EGR cooler disposed downstream of the EGR valve and in direct fluid communication with the EGR valve, wherein the EGR cooler is disposed upstream of and in fluid communication with the compressor; and
an intercooler disposed downstream of and in fluid communication with the compressor, and disposed upstream of and in fluid communication with the intake manifold.
